(19) United States
(12) Patent Application Publication
(10) Pub. No.: US 2001/0036524 A1
(43) Pub. Date: Nov. 1, 2001

(54) Label for a data storage device

(76) Inventor: Collin D. Anderson, Chicago, IL (US)

Correspondence Address: LLOYD L. ZICKERT, 79 West Monroe Street, Chicago, IL, 69693, US

(21) Appl. No.: 09/844,088

(22) Filed: Apr. 27, 2001

Related U.S. Application Data
(60) Provisional application No. 60/202,760, filed on May 9, 2000.

(51) Int. Cl. B32B 7/06

(52) U.S. Cl. 428/40.1; 283/81; 428/126

(57) ABSTRACT

A label system for a data storage device, such as a memory card or the like, including one or more hingedly connected panels with a base panel mountable on the device and a plurality of label panels foldable onto the base panel wherein the foldable panels are removably held in place on the base panel during use of the device, and an adhesive system for removably attaching a label or series of labels to a data storage device.

This application claims the benefit of my provisional application No. 60/202,760, filed May 9, 2000.

This invention relates in general to a labeling system or assembly for a data storage/memory card or other rewritable or once-writeable electronic storage devices to permit the labeling or relabeling of data stored on the device, and more particularly to a label system including one or more panels attachable to a device with repositionable adhesives, and where multiple panels are provided, one or more panels may be separated from the others to be discarded when re-identification of the data stored is desired.

### BACKGROUND OF THE INVENTION

Recent technology has required the need for storing data developed or usable to move information between a variety of electronic devices, such as digital cameras, computers, portable or stationary audio or video players, video games, and other like devices. For example, digital images are stored in a folder that digital cameras and picture frames recognize as housing pictures. One could take a photo with a digital card or memory stick camera, pop the card or stick into a digital picture frame, and then view the picture. Both secure digital cards and memory sticks are generally classified as memory or data storage cards or devices for storing information for later use.

Such cards or devices usually have erasable memories so that they can be reused time and time again. Thus, the information on the card or device may be constantly changing. The use of memory or data storage cards or devices is proliferating on an exponentially rising numerical basis.

It is also known that the memory/data storage cards or devices may be used in wireless devices, GPS receivers, TV receivers, voice recorders, pagers, modems, and devices still being developed. Heretofore, the information on the top face of the card essentially related to the card type, manufacturer and capacity. Thus, there is a need for relabeling the cards or devices as the information changes.

### SUMMARY OF THE INVENTION

The present invention is in a labeling system for a memory/data storage card or device used by various electronic devices which facilitates the labeling and/or relabeling of information stored on the card or device. This labeling system includes one or more panels generally made of thin but substantially self-supporting paper stock which can be mounted on the card or device and not interfere with the usage of the cards or devices as they are handled, inserted or withdrawn from slotted sockets in electronic devices for reading from and/or inputting information on the card or device.

The labeling system of the invention is attachable by a specially constructed repositionable adhesive system that not only assures positive attachment to a card, but also preferably allows removability without leaving any substantial residue so another labeling system may be efficiently used.

In one embodiment a plurality of hingedly connected or folded label panels are hingedly connected to a base panel wherein the label panels are foldable onto each other and also onto the base panel. A flap is provided to overlie the folded panels and hold the panels in position onto the card when it is being used. When the information changes, the label panel with the identification of the prior information may be removed and one of the other label panels may be provided with an identification of the current information on the card. The label system can be used as necessary until all of the label panels are used up, and thereafter the remainder of the used system can be removed and a replacement label system may be applied to the card.

In another embodiment the label system may include a plurality of accordion folded label panels which all are hingedly connected to each other and also hingedly connected to a base panel that can be mounted onto a memory/data storage card or device. Adhesive is provided on one side of the base panel for attaching the label system to the card or device. Further, adhesive is provided on the label panels for facilitating the hold-down of the panels compactly against the card or device during the time the card or device is being used. The hinge connections between label panels and the base panel are preferably a perforation that defines a fold line and allows easy separation when a label panel has become obsolete due to the recording of different information.

A further embodiment is in the form of a non-fold label system having a single panel that is coated on the side attaching to the card with multiple layers of repositionable adhesive that securely connects the label system to the card while allowing removal without leaving any residue or tearing the label.

It should also be appreciated that the label system of the invention may be used on rewritable/recordable or once-writeable tapes, CD's, DVD's or other rewritable or non-rewritable devices. The label system of the invention could likewise be used on a file folder where the contents change from time to time.

It is therefore an object of the present invention to provide a label system for the purpose of recording information changes from time to time to identify the information on a data storage device.

Another object of the invention is to provide a label system for use on memory/data storage cards or devices for the purpose of recording the identification of the data stored and for changing the identification as needed where information is deleted and new information is stored on the card or device.

A further object of the present invention is to provide a label system having a base panel, a plurality of label panels hingedly connected to each other and to a base panel, and a flap for overlying the panels as they are folded onto each other and to hold them down during the time the card or device is being used.

Another object of the invention is to provide a label system embodiment which includes a base panel and a plurality of label panels in accordion folded relation and which are hingedly connected to each other and hingedly connected to the base panel and which further include means for holding the panels together in a single unit during use of the card or device as it may be inserted into and withdrawn from a slotted socket of an electronic device using the card or device.

Another object of the present invention is to provide a new and improved label system for a memory/data storage card or device which facilitates the relabeling of the card or device as information on the card or device changes and which can be made simply and economically.

Other objects, features and advantages of the invention will be apparent from the following detailed disclosure, taken in conjunction with the accompanying drawings, wherein like reference numerals refer to like parts.

### DESCRIPTION OF THE DRAWINGS

FIG. 1 is a perspective view of a label system according to the invention in open position and mounted on a memory card;

FIG. 2 is a perspective view of the label system in FIG. 1 in folded and closed relation on the card with the closing flap in place to hold the folded panels against the card so that the card may be used in an appropriate device;

FIG. 3 is a side elevational view of the label system of FIGS. 1 and 2 before being mounted on a card with the panels in extended position to illustrate adhesive and silicone coatings applied to the sides of certain panels;

FIG. 4 is a perspective view of a labeling system like the embodiment of FIG. 1 but illustrating the use of a tab on the closure panel for facilitating the separation of the closure flap from the label flaps;

FIG. 5 is a perspective view of the label system of FIG. 4 in folded and closed position onto a memory card and showing the tab in position to facilitate easy lifting of the closure flap;

FIG. 6 is a sheet of label systems like in FIGS. 4 and 5 that are perforated so that they may be separable from each other and where the sheet may be sized to be used in a suitable printer connected to a computer;

FIG. 7 is a perspective view of a further embodiment of the invention and showing a label system where the base panel is mounted on a card and where the label panels include adhesive and silicone coatings so that the panels when accordion folded are held together as a unit;

FIG. 8 is a perspective view of the panel system of FIG. 7 mounted on a card and illustrating the folding of the panel system onto the card and ready for use in a slotted socket of an electronic device;

FIG. 9 is a side elevational view of the panel system of FIGS. 7 and 8 mounted on a card where the label panels are extended and to illustrate the placement of adhesive and silicone coatings so that they coact with each other, and which is taken substantially along line 9-9 of FIG. 7;

FIG. 10 is a perspective view of a no-fold label and shown on a memory card although this label can be used on other data storage devices. including video tapes, CD's and DVD's;

FIG. 11 is a transverse sectional view taken along line 11-11 of FIG. 10;

FIG. 12 is a perspective view of a bi-fold label according to the invention as mounted on a memory card and with the flap or cover in open position;

FIG. 13 is a perspective view of the embodiment of FIG. 12 but illustrating the flap in closed position;

FIG. 14 is a transverse sectional view of the embodiment of FIGS. 12 and 13 taken substantially along the lines 14-14 of FIG. 13;

FIG. 15 is a perspective view of a further embodiment in the form of a tri-fold design that includes a label in mounted position on a memory card and with the foldable panels in open position;

FIG. 16 is a perspective view of the embodiment of FIG. 15 but illustrating one flap or panel in closed position;

FIG. 17 is a perspective view of the embodiment of FIGS. 15 and 16 but illustrating all panels in closed position;

FIG. 18 is a transverse sectional view of the embodiment of FIGS. 15 to 17 and taken substantially along lines 18-18 of FIG. 17;

FIG. 19 is a perspective view of a further embodiment of the invention showing a tri-fold label design mounted on a memory card with the panels in open position and which includes a finger relief feature;

FIG. 20 is a perspective view of the embodiment of FIG. 19 but showing one of the panels in closed position;

FIG. 21 is a perspective view of the embodiment of FIGS. 19 and 20 but illustrating all of the panels in closed position; and

FIG. 22 is a transverse sectional view taken substantially along lines 22-22 of FIG. 21.

### DESCRIPTION OF THE INVENTION

The present invention solves the problem of readily identifying the data/information stored on a memory/data storage card or device and changing that identification from time to time as the information on the card or device changes. As above mentioned, these cards or devices are used in electronic devices for receiving and storing digital signals from various signal generating devices so as to provide the ability to move information between electronic devices.

One form of a storage device is a card, commonly known as an SD card or compact flash, which is 1.43 inches (24 mm) in height, 1.68 inches (32 mm) in width and 0.13 inch (2.1 mm) in thickness. Another memory card, commonly called a multi-media card, is 0.943 inch (24 mm) in height, 1.757 inches (45 mm) in length, and 0.55 inch (14 mm) in thickness. Still another memory card, commonly called a Memory Stick, is 21.5 mm in height by 50 mm in length by 2.8 mm in thickness. Any of the commonly available memory/data storage cards are receivable in slotted sockets of electronic devices that are capable of not only reading stored information but also inputting information onto the cards. And because the information is subject to change as these cards are usable over and over again where stored information may be deleted and new information may be stored, the problem of identifying the current information is solved by the present invention in the provision of a label system that may be easily mounted onto a card and which adds very little in thickness and does not impair the ability of the card to be received in or withdrawn from a slotted socket. Further, the label system is preferably cleanly removable from a card for permitting a new system to be applied to the card as needed.

The label system of the invention may be of the no-fold or fold type, and would include an adhesive system for attaching to a card that would allow removal without leaving a residue or cause tearing of the label.

In one embodiment, the label system of the present invention comprises a plurality of panels of thin self-supporting paper stock that is foldable together in order to provide a packet of label panels mountable onto a memory/data storage card and for the purpose of facilitating the recording of the data or information stored on the card. Also, the label system facilitates the ability to change the identification of the data or information as the card is used again and again.

The label system of the present invention not only utilizes thin paper stock, which may be on the order of about 0.003 to 0.005 inch thick, such that wherein five panels are provided for a system, the total thickness will be between about 0.015 and 0.025 inch, which is less than one-half millimeter to slightly more than one-half millimeter, and which would not add any significant thickness to the thickness of the card itself and therefore not impair its usage in a slotted socket. The embodiments showing a total of five panels includes three panels which are foldable onto themselves and then foldable onto a base panel that is adhesively attached to a memory card, together with a closure member or flap that can come down onto the stack of panels and adhesively engage the last panel to hold the stack of panels in place on the memory card. It will be appreciated that any suitable number of label panels may be provided in the system.

In another embodiment, only four panels are shown, although it will be appreciated that any number of panels may be used for any of the embodiments which illustrate three panels hingedly connected to each other and also to a base panel that is mounted onto the memory card. Adhesive and opposing silicone coatings of infinitesimal thickness are employed for holding each of the panels to each other and also to the base panel in a compact system.

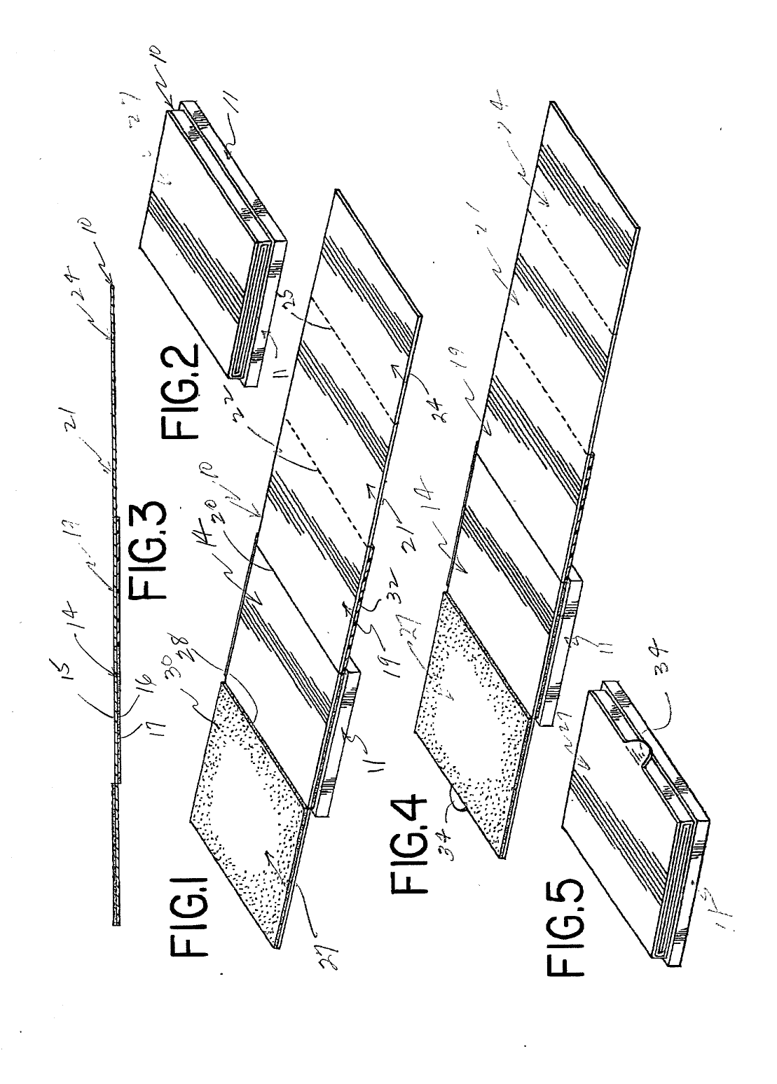

Referring now to the figures and particularly to the embodiment of FIGS. 1 to 3, a label assembly 10, illustrated as being mounted on a memory card 11 in FIGS. 1 and 2, comprises a base panel 14, having a plain upper surface 15, a bottom surface 16 having a film or coating of adhesive 17 thereon so as to be mountable on and attached to the top surface of the memory card 11. The panels are of a suitable paper stock cut to a desired size, and the adhesive is preferably of a suitable semi-permanent type applied by any desired process. A first label panel 19 is hingedly connected along one edge of the base panel 14 at 20. A second label panel 21 is hingedly connected to the opposite edge of the first label panel 19 by a perforation hinge 22, while a third label panel 24 is hingedly connected to the second label panel 21 by a perforation hinge 25. While any number of label panels may be provided, three are illustrated in this embodiment. A closure panel or flap 27 is hingedly connected at the hinge 28 which is opposite the hinge 20 between the base panel 14 and the first label panel 19. The hinges 20 and 28 may be suitably formed such as by a score line. A coating of adhesive 30 is provided on the entire or a suitable part of the top surface of the closure panel 31. The adhesive layer 30 engages a silicone layer or coating 32 on the underside of the first label panel 19 when the label panels 19, 21 and 24 are folded together onto themselves and onto the base panel 14, as shown in FIG. 2. Preferably, the base and label panels are about the same size as the labeling area on the memory card or device. The adhesive 30 may be semi-permanent when coacting with the silicone coating or otherwise of a repositionable type engaging directly onto the surface of the paper stock.

Also illustrated in FIG. 2 is the label panel 24 folded onto label panel 21 and then again onto label panel 19 and then over onto the base panel 14 so that the flap 27 can be brought over the folded label panels to secure the panels in place during usage of the card. It will be appreciated that the thickness in the drawings of the memory cards and panels is not to scale but is for illustration purposes only. As above noted, the total thickness of the label system when in folded position, as shown in FIG. 2, would be about less than one-half millimeter to a little more than one-half millimeter, while the actual thickness of the memory cards exceeds two millimeters. Similarly, the thickness of the adhesive illustrated, as well as the thickness of the silicone coating, is substantially less than the thickness of the paper stock making up the label system, although it would be difficult to differentiate between the paper and the adhesive or silicone layers if they were all drawn to scale.

During usage of the label system in FIGS. 1 to 3, indicia may be applied to either side of the label panels but preferably on the sides that are considered the top sides when the label system is open like in FIGS. 1 and 3. It will be appreciated that the recording of the data or information on the label system first be placed on the outermost label panel 24, and when that information changes and there is a need to use a new label panel such as label panel 21 because of the perforated hinge 25, label panel 24 may easily be separated and removed from the system. Similarly, the use of the label panels 21 and 19 may be used in series as the information changes on the memory card. Once the space on label panels 19, 21 and 24 has been exhausted, then information as to the content of the memory card may be applied to the top surface of the base panel 14. Thereafter, continued use of the memory card and the need for additional space for identifying the contents can be solved by removal of the first label system and replacing it with a new system.

The adhesive layer 17 on the underside of the base panel 15 may preferably be a semi-permanent adhesive for firmly securing the base panel to the memory card during use of the label system. While the adhesive is semi-permanent, it would still allow removal of the base panel from the memory card.

The adhesive layer 30 on the closure flap 27 may be of a semi-permanent type when utilizing a silicone coating as illustrated on the first label panel 19. However, it should be appreciated that it could be of a repositionable adhesive or low-tack adhesive, if desired, and then a silicone coating would not be needed. The entire surface of the closure flap 27 may be covered with adhesive or alternatively only the areas around the edges of the panel. It will further be appreciated that in addition to the ability to print identifying information onto the label panels, the label panels are such that information could be applied by any suitable type of writing instrument such as a ballpoint pen or a pencil. Also, detailed information may be applied to the side of the closure panel which faces upwardly when the closure panel is in closed position, as shown in FIG. 2.

In order to facilitate the hinging of the first label panel and the closure panel to the base panel, the hinge may be creased or scored so as to assure ease of folding over as needed. Further, the actual sizes of the label panels 19, 21 and 24 as to the dimension along the panels between hinge connections may be slightly diminished from the outermost to the innermost panel in order to facilitate the folding of the panels onto each other and onto the base panel. Also, the dimensional size of the closure panel may be such as to facilitate its ability to easily fold over onto the folded label panels. With respect to the dimensions of the base panel, the closure flap and the label panels, the dimensions between hinges will be considered the height, while the dimensions between opposite edges of the panels may be considered the width. All of the panels may preferably be made slightly less than the width of the memory card and slightly less than the height of the memory card so that the label system will easily be applicable to the memory card when mounted thereon.

It may also be appreciated that the various base and label panels and the closure flap may be of the same or different colors if desired. Once the closure flap is in position, as shown in FIG. 2, it will be appreciated that the label system is closed for facilitating the use of the memory card in a slotted socket of an electronic device.

It may also be appreciated that detailed information of the content of the memory card may be applied to the base panel and/or any of the label panels. A summary of the information may be applied to the user side of the closure flap. While the embodiment of FIGS. 1 to 3 is shown where the panels and the closure flap are rectangular in shape, it may be appreciated that they may take any other suitable shape which would still allow the folding of panels one on the other and the use of the closure flap to hold the panels down on the memory card. Once the label panels are folded together and the closure flap is brought down over the label panels, as shown in FIG. 2, and it is desired to open the label system, it is very easy to get under one corner of the closure flap and lift it up to disengage the adhesive on the closure flap from the silicone layer on the first label panel 19. Thereafter, one or more of the label panels 24 or 21 may be removed and/or different information may be applied to any of these panels to indicate any other information that has been inputted to the memory card.

The embodiment of FIG. 4 differs from the embodiment of FIGS. 1 to 3 only in that a tab 34 is provided on the free end of the closure panel or flap 27 to facilitate the opening of the label system from the closed position shown in FIG. 5. This tab is generally centrally located between the opposing edges of the closure flap and extends outwardly such as to at least overlie the folded label panels 19, 21 and 24, as generally illustrated in FIG. 5. It should be appreciated that the tab alternately may be long enough so that it extends downwardly over at least a part of the memory card 11. Further, it should be appreciated that while the tab generally would have no adhesive on the side facing the folded label panels and/or memory card, it could optionally have a low-tack adhesive for engaging the folded label panels and/or the memory card to stabilize its position when the label system is closed.

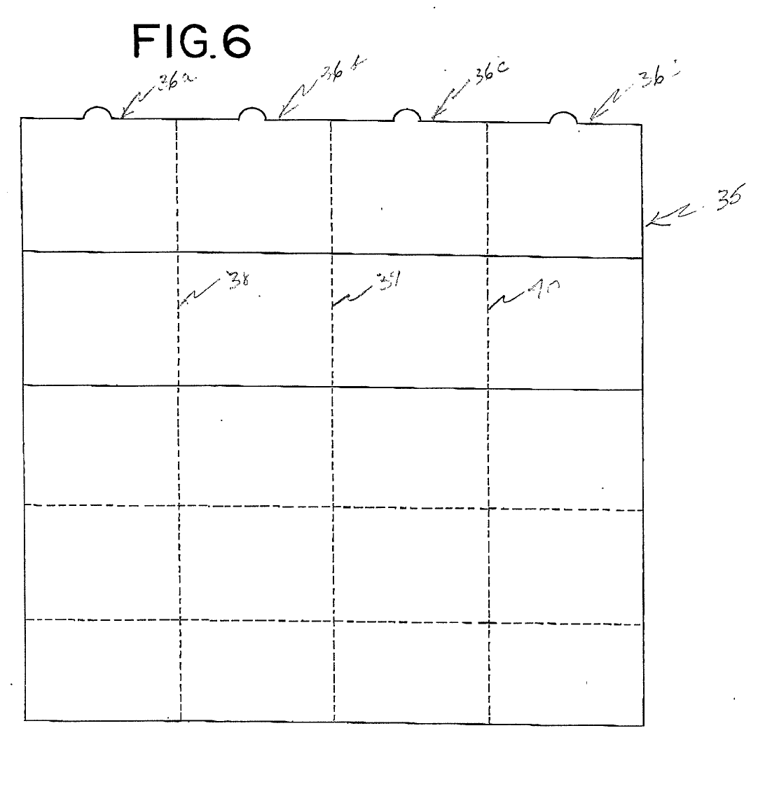

A sheet 35 of label systems is shown in FIG. 6 including a plurality of label systems 36a, 36b, 36c and 36d. These label systems are identical to the embodiment of FIGS. 4 and 5 and are interconnected by perforated areas 38, 39 and 40. When in sheet form, as illustrated in FIG. 6, the sheet of labels may be run through a printer for purposes of applying suitable information relating to the memory cards on which the label systems are to be used. Of course, the label systems need not be preprinted before being used. Separation of the label systems along the perforated areas allows individual use of a label system. Inasmuch as these label systems of the type where the label panels are folded onto each other and onto the base panel before the flap is folded down to hold the label system against a memory card, it will be noted that each of the label panels is sized differently in order to fully facilitate the folding of the label panels onto each other and onto the base panel without causing any binding at the fold lines. The sheet form in FIG. 6 is merely illustrative of one manner in which a plurality of label systems may be initially produced economically for packing and marketing.

It will be appreciated that for purposes of shipping and handling of the sheet of label systems and/or even single label systems according to the invention, a backing film of suitable material will be provided over the adhesive areas in order to prevent the areas from being exposed for unintended engagement with other sheeting material. In this respect, the backing film or layer would be across the inside of the closure flaps and along the backside of the base panel.

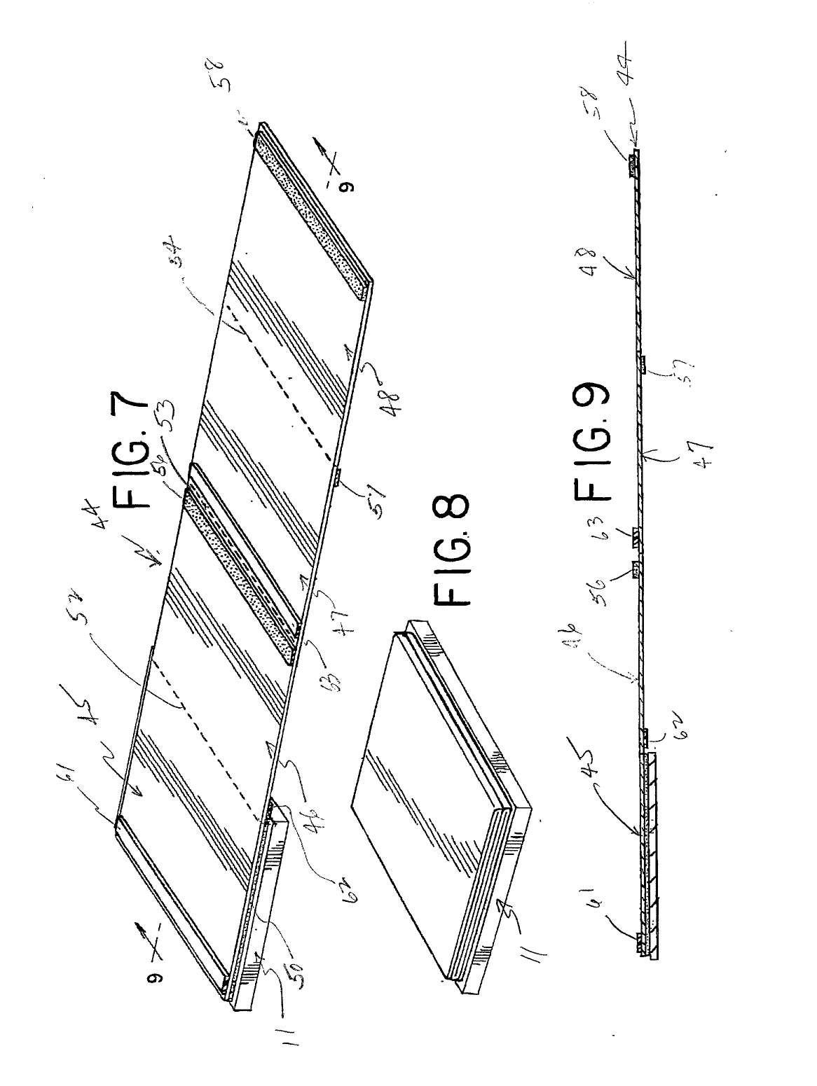

Referring now to the embodiment of FIGS. 7, 8 and 9, a label system is shown where the label panels are accordion folded against each other and onto a base panel. A suitable adhesive is provided on the panels for holding the panels down in folded position against the memory card and as will be more fully explained below.

The label system shown in FIGS. 7 and 8 is generally indicated by the numeral 44 and includes a base panel 45, a first label panel 46 hinged to the base panel, a second label panel 47 hinged to the first label panel, and a third label panel 48 hinged to the second label panel.

The bottom or underside of the base panel 46 includes a layer of semipermanent adhesive 50 for the purpose of allowing the attachment of the base panel onto the memory card 11, as well as subsequent removal therefrom. Each of the label panels includes a strip of adhesive along the end extending farthest from the base panel 45. In this respect, the placement of the adhesive strip is such as to facilitate the accordion folding of the label system. Further, each of the label panels is hingedly connected together and the first label panel is hingedly connected to the base panel by a perforation area which additionally permits separation of the label panels from each other and the first label panel from the base panel. Thus, a perforated hinge 52 hingedly connects the first label panel 46 to the base panel 45, while a perforated hinge 53 hingedly connects the second label panel 42 to the first label panel 46 and a perforated hinge 54 hingedly connects the third label panel 48 to the second label panel 47. As before mentioned, any suitable number of label panels may be provided.

Because the label panels are accordion folded against each other and against the base panel 45, an adhesive strip 56 is provided on the first label panel 46 so that when it is folded against the base panel it will hold down the label panel onto the base panel. Similarly, the second label panel 47 includes an adhesive strip 57 along one end which when this panel is accordion folded against the first label panel 46, it will be held down against that panel by being adhesively connected. Lastly, the third label panel 48 has an adhesive strip 58 at the free end which when accordion folded against the second label panel 47, it will be secured in place against that panel. Thus, all of the panels are held together as a compact unit.

It is appreciated that the adhesive strips 56, 57 and 58 could be repositionable adhesive that could go against a bare surface of the paper stock and yet be easily separated therefrom or a semi-permanent adhesive that would coact with silicone strips on the respective panels against which the adhesive will engage. In this respect, a silicone strip 61 is provided along the free end of the base panel 45 for engaging the adhesive strip 56 on the first label panel 46 when the first label panel is folded along the hinge 52 against the base panel 45. Similarly, a silicone strip 62 is provided on the underside of the first label panel 46 to mate with the adhesive strip 57 on the underside of the second label panel 47 when that panel is accordion folded along the hinge 53 against the first label panel 46. Finally, a silicone strip 63 is provided along the upper side of the second label panel 47 adjacent the hinge 53 for engagement by the adhesive strip 58 on the label panel 48 when the label panel 48 is folded along the hinge 54 against the label panel 47. The accordion folded panels are shown folded in FIG. 8 and the relationship of the adhesive strips and the silicone strips is additionally shown in FIG. 9.

It should again be appreciated that the thickness of the paper stock making up the label system of FIGS. 7 to 9, the adhesive strips and the silicone strips are exaggerated to illustrate the invention. In reality, the entire thickness of the folded label system will be no more than one millimeter and preferably about a half millimeter which will not interfere with the use of the memory card when it is inserted into a slotted socket. The embodiment of FIGS. 7 to 9 does not require the use of a closure or cover flap as do the embodiments of FIGS. 1 to 5. While the label system 44 may also be made in sheet form like that shown in FIG. 6, it can be made in individual form where all of the panels are folded against each other and a backing sheet or film is applied to the exposed adhesive layer 50 on the base panel. This film may easily be removed at the time of mounting the label system onto a memory card.

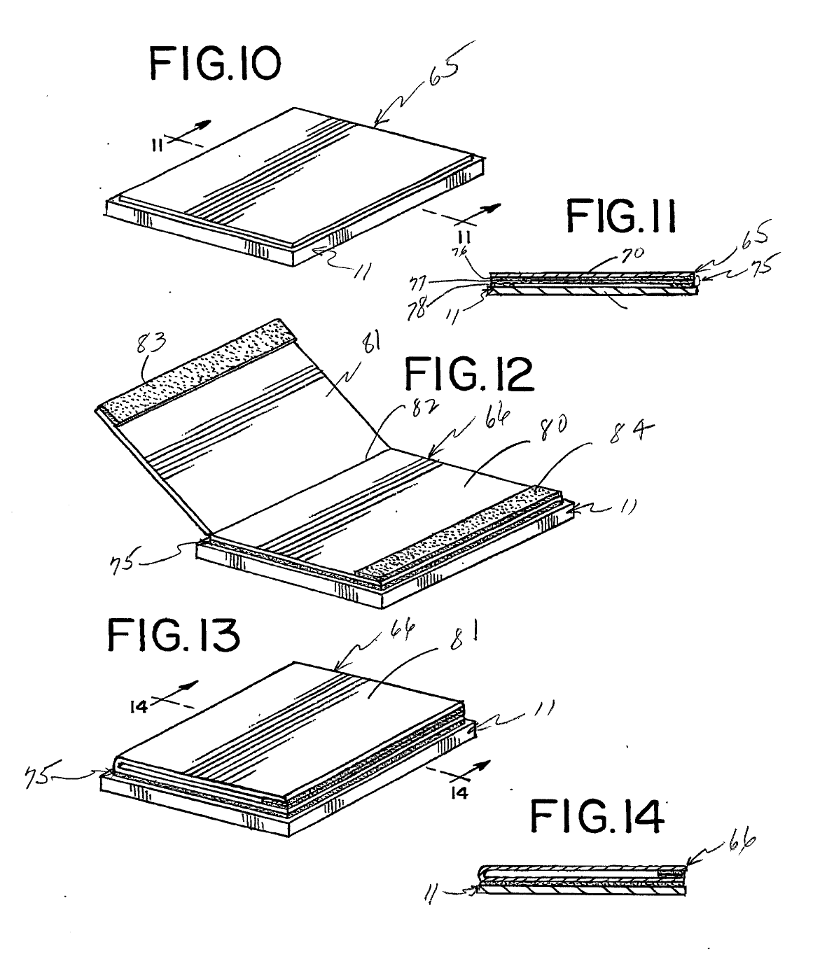

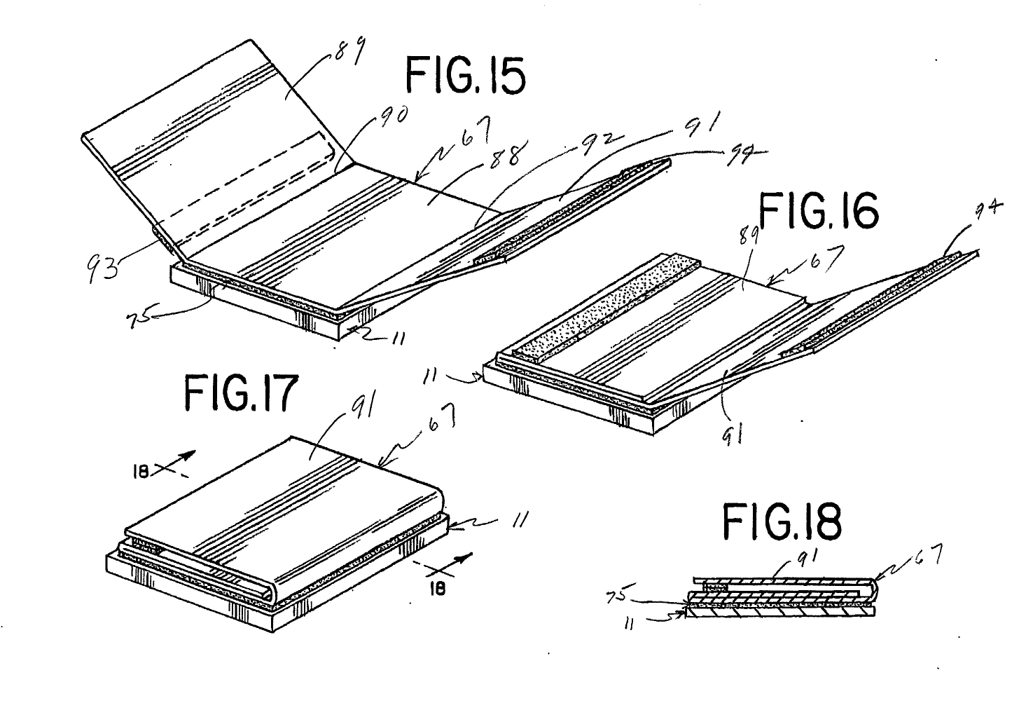

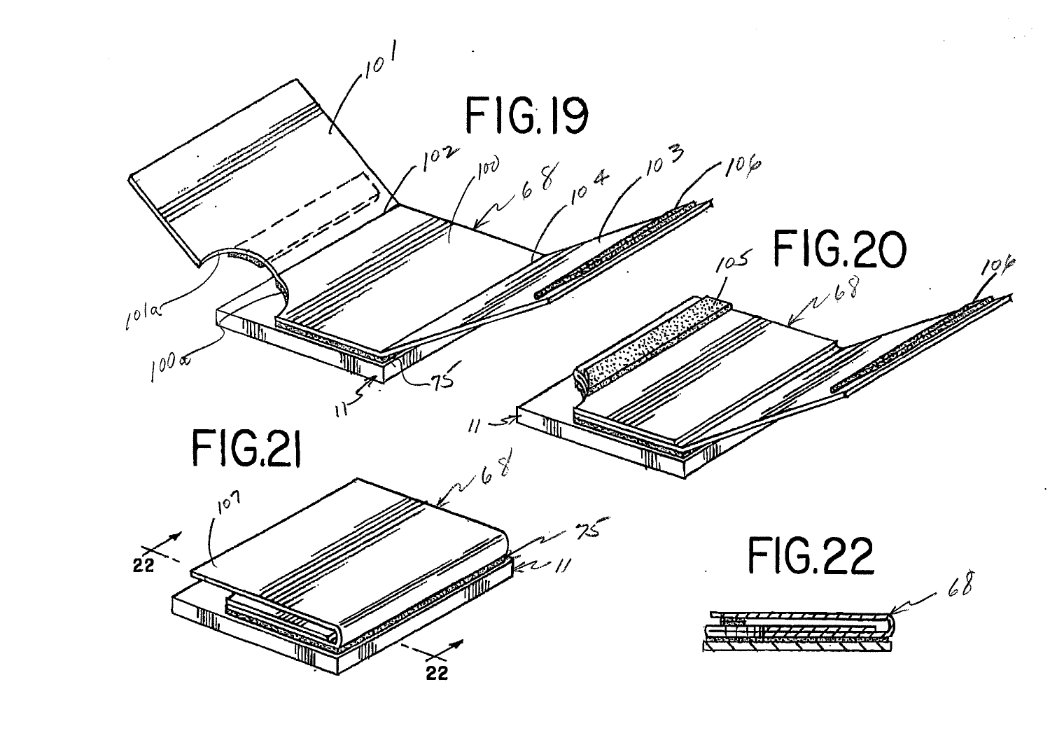

Referring now to the embodiments of FIGS. 10 to 22, a no-fold label is shown in FIGS. 10 and 11 and generally designated by the numeral 65; a bi-fold label is shown in FIGS. 12 to 14 and generally designated by the numeral 66; a tri-fold label is shown in FIGS. 15 to 18 and generally designated by the numeral 67; and a modified tri-fold label having a finger relief portion to facilitate the opening of the panels is shown in FIGS. 19 to 22 and generally designated by the numeral 68. It should also be appreciated that as in FIGS. 1 to 9 the thickness of the paper stock, adhesive strips, and silicone strips are exaggerated in size to illustrate the invention.

Each of the label system embodiments referred to in the above paragraph includes the same adhesive system for attachment of the labels to a data storage device. It will be appreciated that any of these labels may be used on any of the well known data storage devices including rewritable and once-writeable digital data storage devices, such as memory cards and laser readable CD's and DVD's and magnetic data storage tapes such as cassette and video tapes.

One of the advantages of these labels is in the use of a unique adhesive system that produces a strong bond with the surface of the data storage device that still allows removal of the label without tearing of the label and without leaving any residue on the storage device surface where the label was mounted.

The labels of these further embodiments are comprised of one or more panels of thin self-supporting paper stock as above identified in connection with the embodiments of FIGS. 1 to 9 that will not add any significant thickness to the data storage device, and therefore will not impair the usage of the device as it is inserted in a slotted memory device receiving opening of a writeable or recordable and/or readable electronic device.

The adhesive system for the labels of the embodiments of FIGS. 10 to 22 may also be used on the embodiments of FIGS. 1 to 9 and consists preferably of an acrylic based repositionable adhesive obtainable from the Standard Register Corporation. The adhesive is applied to the paper stock by an anilox roll. The adhesive is air-cured such as by subjecting it to drying blowers after each coating is applied by an anilox roll. Inasmuch as an anilox roll may have different line screens, a chosen line screen is used for each coating or bump of adhesive. The first coating is preferably applied with an anilox No. 80 roll; the second coating or bump of adhesive preferably with an anilox No. 120 roll; and the third coating or bump preferably with an anilox No. 200 roll. Each coating or bump is air-dried before the next coating or bump is applied. As above noted, the adhesive system for the labels of the embodiments of FIGS. 10 to 22 include two coatings of adhesive over the entire surface of the stock that will be in engagement with the memory device and a third coating that is generally peripheral of the label that is along the peripheral edge of the label to provide greater bond strength at the periphery of the label.

The adhesive system for all of the label embodiments of FIGS. 10 to 22 will be specifically described with respect to the embodiment of FIGS. 10 and 11 as being applied to one side of the label 65 that includes the paper stock layer 70. The adhesive system, generally designated by the numeral 75, includes a first adhesive layer or coating 76 over the entire undersurface of the paper stock layer 70, a second adhesive layer 77 over the entire surface of the first layer 76, and a third adhesive layer 78 that extends along the periphery or edge of the second layer, all as shown in FIG. 11. The thickness and relationship of the adhesive layers are exaggerated for purposes of explaining the adhesive system. While the second layer 77 is shown in spaced relation to the upper surface of the memory card 11, in reality it will be engaging the surface to adhesively attach the entire paper stock layer 70 to the memory card. In subsequent embodiments, the adhesive system on the paper stock layer side to be attached to the memory device is only illustrated as a single layer, but is the same as in the embodiment of FIGS. 10 and 11. As above mentioned, the first layer has an anilox number of about 80; the second layer 77 has an anilox member of about 120; and the third layer 78 has an anilox member of about 200. Also, as above mentioned, each layer is preferably cured or dried before the application of the next layer.

As illustrated in FIG. 10, the no-fold label 65 is illustrated as being mounted on a memory card 11 although it could be mounted on any suitable memory storage device. Preferably, the label is sized to cover the labeling area of the card or device. Before mounting the label on a memory or data storage device, it could be imprinted with information as to the intended content of the storage device as previously mentioned, or the information may be applied after the label has been mounted on the storage device. It will be appreciated that because of the adhesive system of the label, it will provide a strong bond to the surface of the memory storage device during use of the device that will prevent peeling. Further, the label would be mounted on a suitable liner or backing sheet prior to being used for application to a memory storage device. The backing sheet would be peeled away from the adhesive side of the label just prior to application of the label on a memory storage device.

The repositionable adhesive system provides the unique function of allowing the label to be removed from the memory storage device even after long-time usage without incurring any tearing of the label during removal, and also without leaving any adhesive residue on the memory storage device. Inasmuch as no residue is left on the face of the storage device, it will be appreciated that a new replacement label may be effectively applied to the storage device in the event that the information in the storage device has changed.

Referring now to the bi-fold label embodiment 66 in FIGS. 12 to 14, the label of this embodiment includes a base panel 80 and a cover or top panel 81 foldable over the base panel along a suitable fold line 82 that may be scored or otherwise formed to facilitate the folding of panel 81 onto panel 80. As above mentioned, this embodiment will preferably utilize the same adhesive system 75 as used in the embodiment of FIGS. 10 and 11 for mounting of the label onto a memory storage device wherein the adhesive system 75 is applied to the underside of the panel 80. The panel 81 is substantially the same size as panel 80 and further includes means for maintaining the panel in overlying position to the base panel 80 including a layer or coating of silicon 83 along the free edge which when the panel is folded over will mate and engage an adhesive strip 84 along the free edge of the panel 80. While the adhesive strip 84 may be in the form of repositionable adhesive, it is preferably in the form of a double-sided tape that would be applied to a panel 80 and have a repositionable adhesive surface engageable by the silicon strip 83 on the panel 81. The interaction between the silicon strip and the adhesive strip 84 allows the panel 81 to be selectively maintained in closed position when panel 81 is folded onto panel 80 and to be openable when desired. Identifying information may be applied to the top surface of the panel 80 or either surface of the panel 81 as desired. Again, when the label 66 has served its function and it is desired to replace it with a new label, because of the adhesive system 75 on the label, it may be easily removed from the memory card or memory storage device without tearing the label and preferably without leaving appreciable adhesive residue on the surface of the memory storage device. The label 66 is shown in open mode in FIG. 12 and in closed mode in FIG. 13.

The tri-fold label 67, shown in FIGS. 15 to 18, includes a base panel 88, a first foldable panel 89 of about the same size as the panel 88 and foldable along fold line 90, and a third panel 91 of about the same size as the panels 88 and 89 and foldable along a fold line 92. In reality, the dimension of the panel 89 between the fold line 90 and its free edge would be slightly less than the dimension of the panel 88 between fold lines 90 and 92 so as to facilitate the folding over of panel 91 onto panel 89. On the top surface of the panel 89, a strip of repositionable adhesive or double-sided adhesive tape 93 is provided directly adjacent to the edge of the panel at the fold line 90 to coact with a silicon strip 94 disposed on the underside of panel 91 and along the free edge of the panel opposite the fold line 92. Thus, when the panel 89 is first folded against the base panel 88, the third panel 91 can be folded against the second panel 89 so that the adhesive strip 93 engages the silicon strip 94 to maintain and hold the foldable panels in closed position on the base panel 88.

As with the embodiment of FIGS. 12 and 14, the silicon strip facilitates the separation from the adhesive strip on the panel 89 to allow the panels to be moved to open position, as shown in FIG. 15. When closing the panels or flaps, the second panel 89 is first folded over the base panel 88, as shown in FIG. 16, and thereafter the third panel 91 may be folded over onto panel 89 so that the adhesive strip engages the silicon strip to maintain the panels in closed position, as shown in FIGS. 17 and 18.

As in the previous embodiment, identifying information may be applied to the top of the base panel and either sides of the foldable panels 89 and 91 during usage of the label. Further, when the label usage has been exhausted and it is desired to replace it with another label, it may easily be peeled from the memory storage device without tearing the label or leaving any adhesive residue on the memory storage device surface from which it is being removed. It should also be appreciated that the positions of the adhesive strip 93 and the silicon strip 94 may be reversed if so desired, wherein the silicon strip would be applied to the panel 89 and the adhesive strip applied to the panel 91. The same reversal of the position of the strips may be employed in the bi-fold label shown in FIGS. 12 to 14.

A modified tri-fold label 68 with a finger relief feature is shown in FIGS. 19 to 21 and which generally includes a base panel 100, a first foldable panel 101 foldable along a fold line 102 onto a base panel 100, and a second foldable panel 103 foldable onto the first foldable panel 101 along a fold line 104. As in the other embodiments, the underside of the base panel includes an adhesive system 75 for mounting of the label onto a memory storage device.

When the first foldable panel 101 is folded onto the base panel 100, it will expose on its top side a strip of repositionable adhesive 105 or double-sided adhesive tape to mate with a strip of silicon 106 on the underside of the second foldable panel 103 when it is folded onto the first foldable panel 101. Engagement of the silicon strip with the adhesive strip will then maintain the foldable panels in folded position on the base panel. Again, it will be appreciated that the positions of the adhesive strip and the silicon strip may be reversed if desired, wherein the silicon strip would be on the first foldable panel and the adhesive strip would be on the second foldable panel. In order for the silicon strip to mate with the adhesive strip, the adhesive strip 105 is placed along the edge of the foldable panel 101 adjacent the fold line 102, while the silicon strip 106 is placed along the free edge of the panel 103 opposite the fold line 104. This embodiment includes a finger relief feature to facilitate the opening of the label when the panel 103 is lifted and separated from the panel 101 at a time when the label is opened for exposure of the inner sides of the label. This finger relief feature is constructed by providing a notch 100a in the base panel 100 and a coacting notch 101a in the first foldable panel 101 so that when the first foldable panel is folded onto the base panel, as seen in FIG. 20, and looking down onto the label, it appears that there is a notch out of the left-hand lower corner of the label. When folding over the second foldable panel 103, which is sized to be in overlapping position with the notch, a tab 107, as seen in FIG. 21, coacts with the notched areas of the base panel and a first foldable panel so that a finger may be positioned underneath the tab to facilitate the opening of the second foldable panel relative to the first foldable panel.

It will be appreciated that this feature could likewise be incorporated into the bi-fold label 66 by notching the base panel at one of the corners opposite the free edge of the fold line 82. Accordingly, the finger relief feature facilitates the opening of multi-panel labels.

It will be appreciated that when use of this label is exhausted, it may likewise be easily removed from the memory storage device as above described without tearing the label or leaving any appreciable adhesive residue on the surface of the memory storage device.

While the label systems shown in the drawings is adapted for use in a memory/data storage card, it should be appreciated that it could easily be sized for use on any rewritable or once-writeable data storage device used to store retrievable information, such as rewritable compact discs (CD's) or DVD's. It also could be sized for use on any other type of memory unit.

It will be understood that modifications and variations may be effected without departing from the scope of the novel concepts of the present invention, but it is understood that this application is to be limited only by the scope of the appended claims.

The invention is hereby claimed as follows:

1. A label for a data storage device comprising:
a base panel having repositionable adhesive on one side for attachment of the panel to the device,
a plurality of interconnected label panels foldable onto themselves and connected to said base panel,
and a flap connected to said base panel for overlapping said label panels when they are folded onto themselves and for selective placement on said base panel,
said flap having means for temporarily fastening said label panels in place when using the device.

2. The label of claim 1, wherein the repositionable adhesive includes a plurality of layers or bumps of repositionable acrylic-based adhesive.

3. The label of claim 2, wherein at least one bump of adhesive is over the entire base panel, and another bump is patterned to extend along the periphery of the base panel.

4. The label of claim 2, wherein first and second bumps of adhesive are over the entire base panel, and a third bump of adhesive is patterned along the periphery of the base panel.

5. The label of claim 1, wherein the label is rectangularly shaped.

6. The label of claim 1, wherein said label panels are connected to each other by a perforated or scored hinge that allows easy removal of the endmost label panel from the next adjacent label panel.

7. The label of claim 1, wherein said flap fastening means includes a repositionable adhesive engaging the last folded panel.

8. The label of claim 7, wherein the flap adhesive opposes a silicone coating on the last folded panel to enhance the separation of the adhesive when opening the label.

9. The label of claim 1, which further includes a tab at the free end of the flap which overlies the folded label panels and facilitates lifting of the flap to open the label.

10. The label of claim 9, wherein said tab includes repositionable adhesive on the side overlying the folded label panels.

11. The label of claim 1, wherein the adhesive on the base panel is semi-permanent, and the fastening means on the flap includes a repositionable adhesive.

12. A label for a memory card comprising:
a base panel having adhesive on one side for attachment of the panel to the memory card,
a plurality of hingedly connected label panels accordion folded with respect to each other and hingedly connected to said base panel for selective placement thereon,
and means on said base and label panels for removably attaching the panels together when folded and placed on the base panel.

13. The label of claim 12, wherein said hingeable connections include perforations for tear-away separation.

14. The label of claim 12, wherein said removably attaching means includes adhesive on selected label panels.

15. The label of claim 14, wherein said panel adhesive is repositionable.

16. The label of claim 14, wherein a silicone film/coating is provided on the portions of panels opposite from the panel adhesive.

17. The label of claim 13, wherein each label panel is of the same size and substantially the same size as the base panel.

18. The label of claim 17, wherein the base and label panels are about the same size as the labeling area of the memory card.

19. The label of claim 18, wherein said removably attaching means includes adhesive along one edge of each label panel and a silicone coating along a corresponding edge of the base or label panels.

20. A label system of paper stock for a data storage card comprising:
a base panel sized to be mounted on said card,
adhesive on one side of the base panel for attaching the panel to said card,
a plurality of folded label panels hingedly connected to each other and hingedly connected to said base panel,
and means for maintaining said label panels in mounted position on said base panel.

21. The label system of claim 20, wherein said maintaining means includes a flap for overlying and removably securing said label panels to said card.

22. The label system of claim 20, wherein said maintaining means includes adhesive on said base and label panels.

23. The label system of claim 20, wherein said label panels are folded onto each other.

24. The label system of claim 20, wherein said label panels are accordion folded.

25. A label system for use in identifying the contents of a file or a rewritable disc comprising:
a base panel having adhesive on one side for attachment to said file/disc,
a plurality of label panels hingedly connected to each other and to said base panel for folding onto the base panel,
and means for holding down the panels on the base panel during use of the file/disc.

26. A label for a data storage device comprising:
a substrate of material sized to overlie and be removably attached to said device,
said substrate having upper and lower sides,
the upper side being writeable for indicating the substance of the data stored in the device,
the lower side having an adhesive system for adhesively attaching the substrate to the device,
said adhesive system including a plurality of layers of repositionable acrylic-based repositionable adhesive,
whereby the label may be removed without tearing the label or leaving any adhesive residue on the device.

27. A label for substantially covering the labeling area of a data storage device, said label comprising:
a substrate of substantially opaque writeable or printable material, said substrate having a top side for receiving indicia thereon and a bottom side having an adhesive system for adhesively attaching the label to the device, and
said adhesive system including a first layer of repositionable acrylic-based adhesive over substantially the entire bottom side of the substrate,
a second layer of repositionable adhesive over said first layer of adhesive, and
a patterned layer of repositionable adhesive over said second layer of adhesive in the form of a strip at the periphery of the second layer.

28. The label of claim 27, wherein the first layer is applied with an anilox No. 80 roll, the second layer with an anilox No. 120 roll, and the patterned layer with an anilox No. 200 roll.

29. The label of claim 27, which further includes at least one panel hingedly connected along one edge of the substrate and foldable over the substrate, and means for selectively maintaining the panel in overlying position on the substrate.

30. The label of claim 27, which further includes a first panel hingedly connected along one edge of the substrate and foldable over the substrate, a second panel hingedly connected to an opposite edge of the substrate and foldable over the first panel, and means on the second panel for selecting and maintaining said panel in overlying position on the first panel.

31. The label of claim 29, which further includes a finger relief to facilitate lifting of said one panel from said substrate.

32. The label of claim 30, which further includes a finger relief to facilitate lifting of said second panel from said first panel.

33. The method of making a label for a data storage device for adhesive attachment thereto and easily removable therefrom without tearing the label or leaving appreciable adhesive residue on the device, said method comprising the steps of:
providing a substrate sized to substantially cover the labeling area of the device and on which identification information may be written on one side and adhesive may be applied to the other side,
applying at least one bump of repositionable acrylic-based adhesive over the entire said other side of said substrate,
drying said bump of adhesive,
applying a patterned bump of repositionable acrylic-based adhesive to said one bump of adhesive in the form of a strip at the periphery of said one bump, and
subjecting the patterned bump of adhesive to a source of drying air.

34. The method of claim 33, wherein two bumps of repositionable acrylic-based adhesive are successively applied over the entire said other side of the substrate and each is dried.

35. The method of claim 33, wherein the adhesive is applied with an anilox roll.

36. The method of making a label for a data storage device for adhesive attachment thereto and easily removable therefrom without tearing the label or leaving an appreciable adhesive residue on the device, said method comprising the steps of:
providing a substrate sized to substantially cover a labeling area on one side of the device and on which said substrate information may be written on one side thereof and adhesive may be applied to the other side, thereof
applying a first bump of acrylic-based adhesive over the entire said other side of said substrate,
curing said first bump of adhesive,
applying a second bump of acrylic-based adhesive over the entire first bump of adhesive,
curing said second bump of adhesive,
applying a third annular bump of acrylic-based adhesive at the outer periphery of said second bump of adhesive, and
curing said third bump of adhesive.

37. The method of claim 36, wherein the adhesive is applied with an anilox roll.

38. The method of claim 37, wherein said first bump of adhesive is applied with an anilox No. 80 roll, the second with an anilox No. 120 roll, and the third with an anilox No. 200 roll.
